(19) United States
(12) Patent Application Publication
(10) Pub. No.: US 2007/0005893 A1
(43) Pub. Date: Jan. 4, 2007

(54) Correlated logic micro cache

(75) Inventor: John W. Mates, Portland, OR (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/173,850

(22) Filed: Jun. 30, 2005

(51) Int. Cl. G06F 12/00

(52) U.S. Cl. 711/118

(57) ABSTRACT

A correlated logic micro cache and approach for correlated logic micro-caching. For one aspect, logic coupled to an output node is provided to at least initiate computation of an output value in response to receiving an input value at an input node. A correlated logic micro cache is provided to store information sufficient to recover a first input value associated with the input node and a first output value associated with the first input value. If a second input value to be applied at the input node matches the first input value stored in the correlated logic micro cache, the first output value is to be applied at the output node and computation by the logic is to be halted.

### BACKGROUND

An embodiment of the present invention relates to the field of electronic systems and, more particularly, to an approach for integrated circuit performance improvement and/or power reduction.

In the field of integrated circuit design, particularly for very large scale integration (VLSI) designs, performance and power consumption are typically key focus areas. More specifically, it is generally desirable to design an integrated circuit with a goal of achieving high performance and low power consumption where possible.

### BRIEF DESCRIPTION OF THE DRAWINGS

The present invention is illustrated by way of example and not limitation in the figures of the accompanying drawings in which like references indicate similar elements, and in which:

FIG. 1 is a high-level block diagram of an integrated circuit that may include one or more correlated logic micro caches and associated logic of one embodiment.

FIG. 2 illustrates a correlated logic micro cache and associated logic of one embodiment that may be used to provide the correlated logic micro cache and associated logic of FIG. 1.

FIG. 3 is a high-level block diagram of an integrated circuit that may include one or more correlated logic micro caches and associated logic of another embodiment.

FIG. 4 illustrates a correlated logic micro cache and associated logic of one embodiment that may be used to provide the correlated logic micro cache and associated logic of FIG. 3.

FIG. 5 is a block diagram of a system of one embodiment that may include the correlated logic micro cache of one embodiment.

FIG. 6 is a flow diagram illustrating a method of one embodiment for correlated logic micro caching.

### DETAILED DESCRIPTION

A method and apparatus for correlated logic micro-caching are described. In the following description, particular components, circuits, cache memory architectures, etc. are described for purposes of illustration. It will be appreciated, however, that other embodiments are applicable to other types of components, circuits, and/or cache memories, for example.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

Aspects of embodiments of the invention may be described for purposes of illustration as being implemented in one of hardware, firmware or software. It will be appreciated that such aspects may instead be implemented in a different medium.

One way to improve the performance of an integrated circuit while reducing the power consumption of that circuit is to avoid computing signal values that have already been computed. For example, currently, instruction caches, data caches, translation look-aside buffers, etc. are used to benefit from expected localities of time and space with respect to architectural objects such as memory addresses, operand values, predicted branches, etc.

Frequently, the behaviors of apparently architecturally unrelated circuit functions in complex integrated circuits may also be correlated. Such correlations may exist in addition to those that would be expected when viewing a circuit only with respect to its architecture, and may also benefit from correlated logic micro-caching as described in more detail below. For example, a circuit simulation of a given Register Transfer Language (RTL) model driven by given input traces, may expose correlations between “input” and “outputs” that cannot or cannot easily be described in terms of circuit architectural abstractions. The result may simply indicate that activity at one point predicts activity at another point.

More specifically, for one embodiment, logic is provided to at least initiate computation of an output value to be applied at an output node in response to receiving an input value at an input node. A correlated logic micro cache is also provided to store information sufficient to recover a first input value associated with the input node and a first output value associated with the first input value, the first output value to be applied at the output node and computation by the logic to be halted if a second input value to be applied at the input node matches the first input value.

Further details of this and other embodiments are provided in the following description.

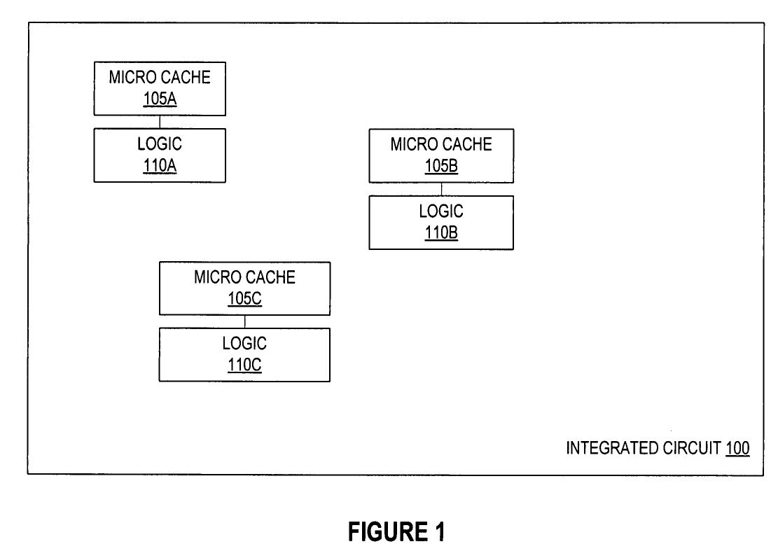

FIG. 1 is a high-level block diagram of an integrated circuit 100 of one embodiment that may implement one or more correlated logic micro-caches such as example correlated logic micro caches 105A-105C. As described further herein, correlated logic micro-caches may just cache one or a few frequently computed input-output pairs related to associated logic and may operate to reduce power consumption and/or improve performance in circumstances, for example, where the associated logic 110A-110C, respectively, would otherwise repeatedly compute the very same output. The integrated circuit 100 may be any type of integrated circuit such as, for example, a processor (e.g. a microprocessor, a digital signal processor, a graphics processor, etc.), a peripheral (a memory controller, an input/output controller, etc.) or another type of integrated circuit device for which it is desirable to improve performance and/or reduce power dissipation.

While three example correlated logic micro-caches 105A-105C and associated logic 110A-110C are shown in FIG. 1 at various locations on the integrated circuit 100, it will be appreciated that an integrated circuit according to one or more embodiments may include a different number of correlated logic micro-caches 105 at different locations.

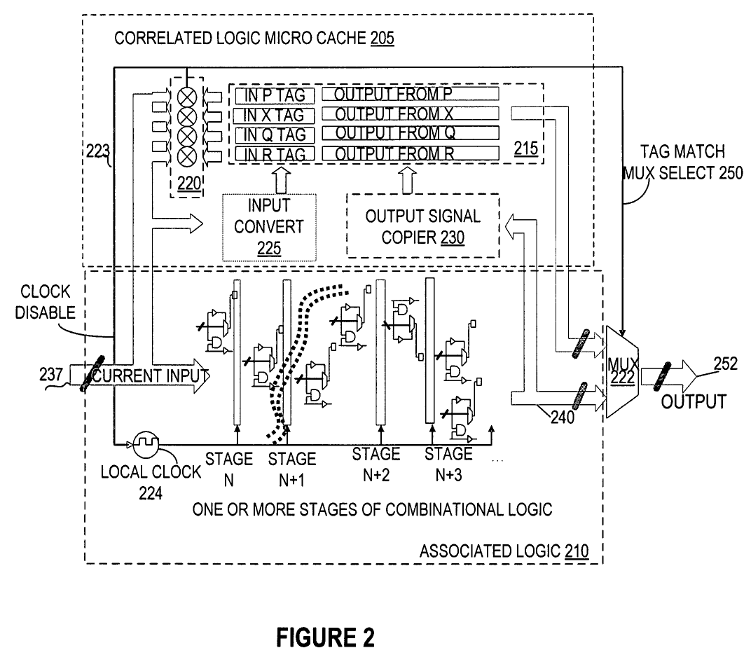

FIG. 2 shows a correlated logic micro-cache 205 of one embodiment that may be used to provide one or more of the correlated logic micro caches 105 of FIG. 1, for example, and associated logic 210. The correlated logic micro cache 205 of this embodiment includes a cache memory 215 including four tags (IN TAGS P-R) and associated cache lines P-R (OUTPUT FROM P-R). It will be appreciated that a different number of tags and cache lines may be included for other embodiments. For a simple case, for example, a correlated logic micro cache may include only one tag/cache line pair. One or more of the tags/cache lines may be implemented using registers or another data storage structure.

The example correlated logic micro-cache 205 also includes comparator(s) 220 that provide the capability to compare an input value X received at an input of associated logic 210 with each of the input tags of the micro cache 215 and to indicate whether the comparison is a “hit” or a “miss.” Output(s) of the comparator(s) are coupled to a select input of a multiplexer (mux) 222 and a clock disable signal line 223 coupled to a local clock 224 used to clock the associated logic 210. Additionally, the correlated logic micro-cache 205 may include logic 225 to convert an input value into a tag and logic 230 to copy an output signal to a data line of the correlated logic micro cache memory 215. Additional circuitry and/or logic may be provided for various embodiments.

For one embodiment, the cache tags P-R are capable of storing one or more input values for the associated logic 210. The corresponding cache lines P-R are capable of storing output value(s) that are provided at an output of the associated logic 210 in response to the corresponding input value(s).

For another embodiment, one or more of the tag and/or the cache lines may instead store information sufficient to recover an input value and/or associated output value. For example, an input and/or output value may be compressed, encoded, encrypted or otherwise represented in the tag and/or the cache line, and then recovered using additional circuitry (not shown).

Further, the correlated logic micro cache memory 215 may include additional storage for some embodiments to track most and/or least recently used information, indicate the validity data, and/or provide other information related to a particular tag and/or cache line.

The associated logic 210 includes one or more stages of combinational logic. For the example shown in FIG. 2, four stages of combinational logic are depicted, but it will be appreciated that a different number of stages may be included for other embodiments.

In operation, an input value or set of input values X may be received at an input node 237 and provided both to comparator(s) 220 and to associated logic 210. Computation of an output value by associated logic 210 may then proceed concurrently with a comparison of the input value X and input value(s) associated with information stored in input tags P-R.

If the input value(s) X is identified as a hit when compared with input tags P-R, then a tag match mux selector signal may be asserted on the signal line 250, and a clock disable signal may be asserted on signal line 223. The associated output value from the corresponding cache line may be provided at the input to the mux 222 over the signal line 235 if it is not already being provided as described in more detail below. Assertion of the tag match signal causes the mux 222 to selectively provide the cached output from the associated cache line at an output node 252. Further, assertion of the clock disable signal on the signal line 223 causes the local clock 224 to be disabled and computation by associated logic 210 to be discontinued. In this manner, power consumption and/or computation time associated with full computation of an output value in response to input value(s) X may be reduced.

If the input value X is instead determined to be a miss when compared to input values stored in the correlated logic micro cache memory 215, the tag match mux selection signal on the signal line 250 is deasserted and the output of associated logic 210 is instead selectively provided to the output node 252.

Any one of a variety of different approaches may be used to design the correlated logic micro cache 205 and associated logic 210 and/or downstream logic (not shown) of various embodiments such that a valid output value is provided at the output node 252 regardless of whether a computed or cached output value is used. For one embodiment, for example, the correlated logic micro cache 205 and associated logic 210 may be designed such that the delay associated with providing a cached output value is substantially the same as the delay associated with providing a computed output value. This may be done, for example, by padding the path for the cached output value with additional clock cycle(s) as needed. For such embodiments, while there may not be performance benefits associated with using the correlated logic micro cache, there may be a power savings as a result of halting computation upon detecting a correlated logic micro cache hit.

For other embodiments, for example, downstream (or dependent) circuits (not shown) may be designed such that they are ready for the output value at the node 252, whether via a fast correlated logic micro cache hit or via a slower cache miss (computation). For such embodiments, a “valid” bit (not shown) or other similar approach may be used to indicate valid output data.

For some embodiments, in the case of a miss, the new input value(s) is stored as a new or replacement tag and the associated output value(s) calculated by the associated logic may be stored as a new/replacement cache line entry in the correlated logic micro cache memory 215. If the correlated logic micro cache memory 215 is determined to be full, one of the tag/cache line pairs (or the only tag/cache line pair in the case of a single entry memory) may be replaced with the new input value/output value pair. Where multiple tag/cache line pairs are provided and most/least recently used information is tracked, the least recently used tag/cache line may be replaced. A different approach may be used for other embodiments to determine which cache line to replace where the correlated logic micro cache memory includes multiple cache lines.

For one embodiment, for subsequent operation, the correlated logic micro cache 205 may speculatively predict that the next input value or set of input values will be the same as the previous input value(s). In this case, the previous output value may be speculatively provided at the correlated output and the correlated output is replaced or computation proceeds only in the event that the input value changes or is not found in the correlated logic micro cache memory, respectively.

Further, for some embodiments, the tag match mux selection signal may be a “sticky” signal, i.e. it may remain asserted until a miss is detected, thereby continuously selecting the same output value(s) until the input value(s) change.

For some embodiments, the correlated logic micro cache memory 215 may be invalidated or set to an impossible value upon power up or reset of the integrated circuit including the correlated logic micro cache memory 215. For other embodiments, the correlated logic micro cache memory 215 may be in an indeterminate state upon power up of the integrated circuit chip 210 and it is loaded with valid data during operation as described above. For still other embodiments, predetermined input/output value(s) may be loaded into correlated logic micro cache memory 215 from a separate memory upon power-up or reset of a host integrated circuit chip, for example.

To determine where placement and use of a correlated logic micro cache according to one or more embodiments may be particularly advantageous, a variety of different approaches may be used. For one embodiment, for example, applications may be run on a Register Transfer Language (RTL) model of an integrated circuit while nodes are evaluated for correlations between given inputs and outputs that may not otherwise have been identified. This type of evaluation may be performed, for example, concurrently with toggle coverage evaluation. Such correlations may be identified in the behaviors of small parts of large circuits, for example. For some embodiments, different types of applications, e.g. graphics applications versus word-processing or other types of applications, may be run to identify different input(s)/output(s) correlations in different operating environments and/or during the use of different types of applications.

Once such correlations are identified, it can be determined whether the correlation logic micro cache of one or more embodiments may be beneficial in association with the identified correlations, and if so, the number of tag/cache line pairs that is likely to be most advantageous. This evaluation may depend on a variety of factors such as, for example, the most common input/output values for the selected collection of input/output nodes, the size, complexity and/or typical delay through the associated logic, the expected performance improvement/power saving associated with the correlated logic micro cache and/or other factors. If common input/output value combinations are identified, these may be used to pre-load the correlated logic micro cache as described above.

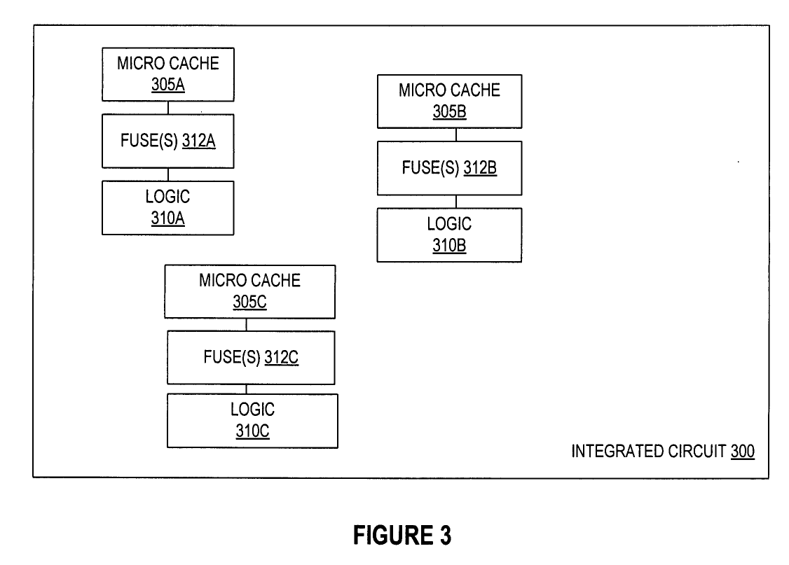

Referring now to FIG. 3, another approach for implementing correlated logic micro caches according to one or more embodiments is shown. For this approach, an integrated circuit 300 may have one or more correlated logic micro caches 305 and associated logic 310 provided on-chip. While example correlated logic micro caches 305A-C and example associated logic 310A-C are shown in FIG. 3, it will be appreciated that a different number of correlated logic micro caches 305 and associated logic 310 may be provided for other embodiments.

In contrast to the embodiment(s) of FIG. 1 and/or 2, however, the correlated logic micro cache(s) 305A-C and respective associated logic 310A-C are each coupled to one or more fuses 312A-C, respectively, such that they may be selectively decoupled after fabrication. In this manner, it may be determined after fabrication, whether or not the use of one or more of the correlated logic micro caches 305 may be beneficial for power conservation and/or performance improvement purposes.

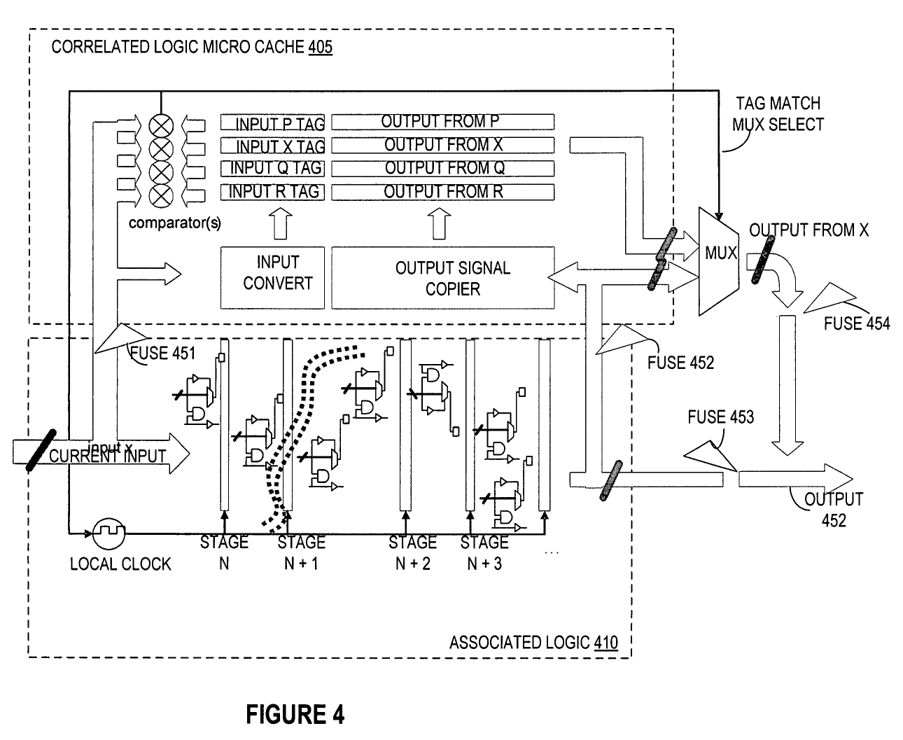

FIG. 4 is a schematic diagram of an example correlated logic micro cache 405, associated logic 410 and fuses 451-454, which may be used to provide one of the correlated logic micro caches 305, associated logic 310 and fuse(s) 312, respectively, of FIG. 3. The fuses 451-454 may be provided by currently known fuses that are programmable after fabrication. Such fuses may be accessible, for example, via programming circuitry (not shown) provided on the host integrated circuit device. An example of such a fuse is described in U.S. Pat. No. 5,708,291 entitled “Silicide Agglomeration Fuse Device,” to Bohr et al., issued Jan. 13, 1998 and assigned to the assignee of the present invention. Other types of fuses that may be programmable after fabrication may be used for various embodiments.

As shown in FIG. 4, if it is determined that the correlated logic micro cache 405 is to be used in association with the associated logic 410, the fuses 451-454 are left un-programmed, i.e. they remain intact. Alternatively, if it is determined that the correlated logic micro cache 405 is not to be used in association with the associated logic 410, then fuses 451-454 are programmed or blown to destroy the connections between the correlated logic micro cache 405 and the associated logic 410. In this case, only a computed output value is provided at the output node 452 and the fused out circuitry is not used.

It will be appreciated that, while the use of four fuses is described above, various embodiments may provide for selective enablement of one or more correlated logic micro caches using a different approach and/or a different number and/or location of fuses or other elements that provide for selective connections after fabrication.

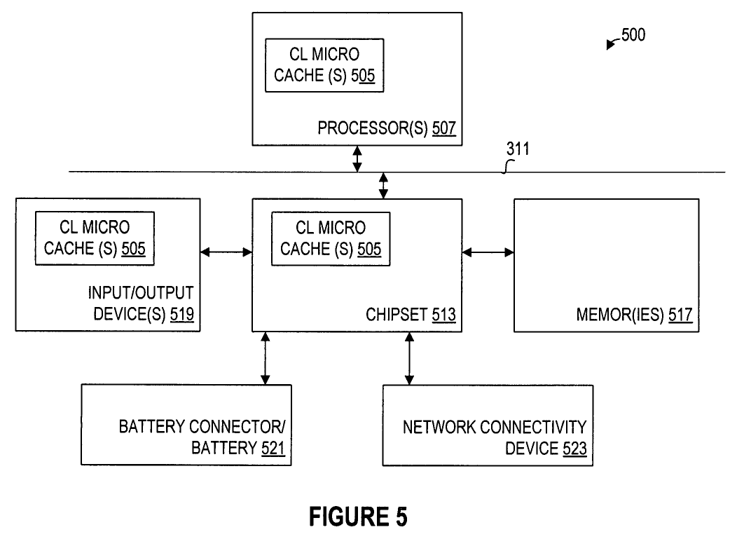

FIG. 5 is a high-level block diagram of a system 500 that may advantageously incorporate one or more correlated logic micro caches of one or more embodiments. The system 500 is a mobile computing platform such as, for example, a laptop, personal digital assistant, wireless communications device or other mobile platform. For other embodiments, a different type of system such as a desktop or enterprise computing system, a set top box or other computing platform, may similarly benefit from the incorporation and use of one or more correlated logic micro caches according to one or more embodiment.

For one embodiment, the system 500 includes one or more single or multi-core processor(s) 507 coupled to a bus 511. Also coupled to the bus 511 is a chipset 513, which may, for example, include memory, graphics and/or input/output control capabilities. One or more memories 517 and one or more input and/or output devices may be coupled to the chipset 513. For some embodiments, a battery connector and/or battery 521 may be coupled to the chipset 513 to provide a power source for the computing platform 500. Further, some embodiments may also include a network communications device such as a Bluetooth device, a wireless or wired local area network device, a modem or other type of device that may provide for connection to a personal, local, wide area or other type of network, for example.

One or more of the components of the system 500 may incorporate one or more correlated logic (CL) micro caches 505 of one or more embodiments. While CL micro cache(s) 505 are shown in FIG. 5 as being incorporated in the processor(s) 507, the chipset 513 and the input/output device(s) 519, it will be appreciated that, for other embodiments, correlated logic micro caches may be implemented on different subsets of components for other embodiments. Further, while the correlated logic micro caches 505 are all identified with the same reference number, they may differ from each other in one or more aspects.

Also, while the example computing system 500 is shown with functionality partitioned in a given way, it will be appreciated that different systems may be partitioned in a different manner.

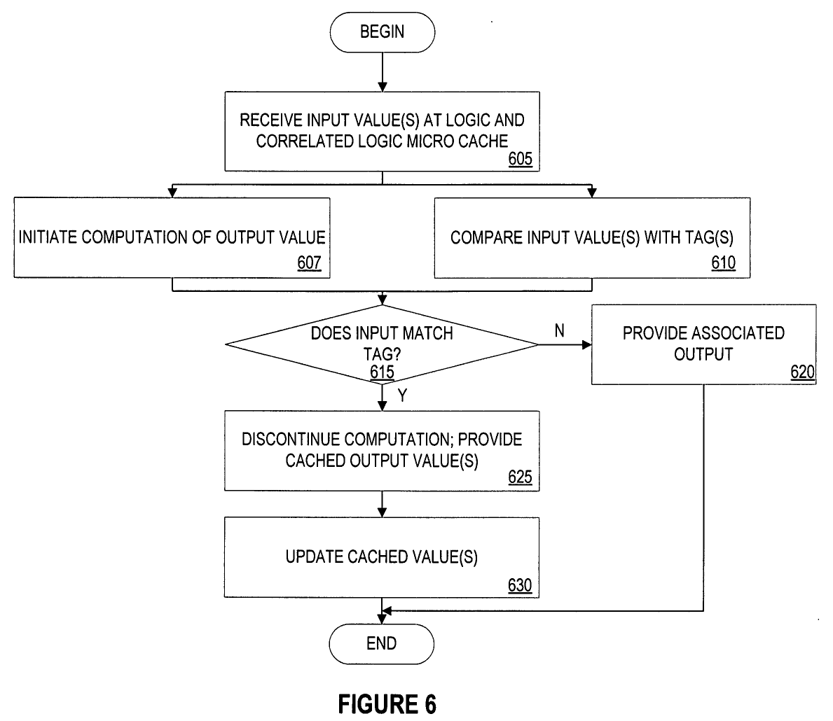

FIG. 6 is a flow diagram showing a method of one embodiment for correlated logic micro-caching. At block 605, an input value is received at an input node of first logic and concurrently provided to an associated correlated logic micro cache. At block 607, computation of an output value associated with the input value is at least initiated by the first logic. Concurrently, at block 610, the input value, is compared with at least a first cached input. At decision block 615, it is determined whether the input matches the at least first cached input. If so, then at block 620, computation by the first logic is halted and an associated cached output value is provided at an output node. If the input is determined not to match the at least first cached input, then at block 625, computation proceeds and a result of the computation by the first logic is provided at the first output node. Optionally at block 630, the correlated logic micro cache may then be updated with the first input value(s) and associated output value(s).

Using the correlated logic micro cache approach of one or more embodiments, it may be possible to save power associated with computation of logic functions that have already been computed and/or that are computed repeatedly. Further, depending upon the logic complexity, a performance improvement may be realized where an output may be accessed from a correlated logic micro-cache rather than being re-computed.

Thus, various embodiments of an approach for correlated logic micro-caching are described. In the foregoing specification, the invention has been described with reference to specific exemplary embodiments thereof. It will, however, be appreciated that various modifications and changes may be made thereto without departing from the broader spirit and scope of the invention as set forth in the appended claims. For example, while specific example circuitry has been described herein, it will be appreciated that different circuitry that accomplishes similar results may be used for other embodiments. The specification and drawings are, accordingly, to be regarded in an illustrative rather than a restrictive sense.

What is claimed is:

1. An apparatus comprising:
logic coupled to an output node to at least initiate computation of an output value in response to receiving an input value at an input node; and
a correlated logic micro cache to store information sufficient to recover a first input value associated with the input node and a first output value associated with the first input value,
the first output value to be applied at the output node and computation by the logic to be halted if a second input value to be applied at the input node matches the first input value.

2. The apparatus of claim 1 further comprising at least one fuse element responsive to a programming signal to selectively decouple the correlated logic micro cache from the logic.

3. The apparatus of claim 1 further comprising
output signal copy logic, the output signal copy logic to cause a second output value associated with the second input value to be stored in the correlated logic micro cache if the second input value does not match the first input value.

4. The apparatus of claim 3 wherein the correlated logic micro cache is to store a representation of the first input value that is not equal to the first input value, the apparatus further comprising conversion logic to convert the first input value into the representation.

5. The apparatus of claim 1 wherein the logic is responsive to a clock disable signal to halt computation if the second input value matches the first input value.

6. The apparatus of claim 5 further comprising at least a first comparator to compare the first and second input values, an output of the comparator to provide the clock disable signal if the first and second input values match.

7. A method comprising:
receiving a first input value at a correlated logic micro cache and associated logic;
at least initiating computation of a first output value associated with the first input value;
comparing the first input value with a second input value, information sufficient to retrieve the second input value being stored in the correlated logic micro cache;
halting computation of the first output value if the first and second input values match; and
providing a second output value stored in the correlated logic micro cache and associated with the second input value at an output node.

8. The method of claim 7 wherein halting computation comprises disabling a clock coupled to the associated logic.

9. The method of claim 7 further comprising:
if the first and second input values do not match, storing the first output value and information sufficient to retrieve the first input value in the correlated logic micro cache.

10. The method of claim 9 further comprising:
if the information sufficient to retrieve the second input value is not equal to the second input value, converting the first input value prior to comparing it to the second input value.

11. A method comprising:
providing logic coupled to an output node to at least initiate computation of an output value in response to receiving an input value at an input node; and
providing a correlated logic micro cache to store information sufficient to recover a first input value associated with the input node and a first output value associated with the first input value,
the first output value to be applied at the output node and computation by the logic to be halted if a second input value to be applied at the input node matches the first input value.

12. The method of claim 11 further comprising
providing at least a first fuse to selectively decouple the correlated logic micro cache from the logic after fabrication.

13. A system comprising:
a bus to communicate information;
a processor coupled to the bus, the processor including
at least a first logic to at least initiate computation of an output value to be provided at an output node in response to receiving an input value at an input node, and
at least a first correlated logic micro cache to store information sufficient to recover a first input value associated with the input node and a first output value associated with the first input value,
the first output value to be applied at the output node and computation by the logic to be halted if a second input value to be applied at the input node matches the first input value; and
a battery connector coupled to the bus to receive a battery to provide a power source for the system.

14. The system of claim 13 wherein the processor further comprises
at least one fuse element responsive to a programming signal to selectively decouple the at least one correlated logic micro cache from the at least one logic.

15. The system of claim 13 wherein the processor further comprises
output signal copy logic, the output signal copy logic to cause a second output value associated with the second input value to be stored in the at least one correlated logic micro cache if the second input value does not match the first input value.

16. The system of claim 15 wherein the at least one correlated logic micro cache is to store a representation of the first input value that is not equal to the first input value, the processor further comprising conversion logic to convert the first input value into the representation.

17. The system of claim 13 wherein the at least first logic is responsive to a clock disable signal to halt computation if the second input value matches the first input value.

18. The system of claim 17 wherein the processor further comprises at least a first comparator to compare the first and second input values, an output of the comparator to provide the clock disable signal if the first and second input values match.
